(19) United States
(12) Patent Application Publication
(10) Pub. No.: US 2004/0030728 A1
(43) Pub. Date: Feb. 12, 2004

(54) Deferred renaming of files

(76) Inventors: Nizamudeen Ishmael, Austin, TX (US); Kulvir Singh Bhogal, Fort Worth, TX (US)

Correspondence Address: Marilyn Smith Dawkins, Intellectual Property Law Department, International Business Machines Corp., 11400 Burnet Road, Austin, TX, 78758, US

(21) Appl. No.: 10/216,626

(22) Filed: Aug. 8, 2002

(51) Int. Cl. G06F 17/30

(52) U.S. Cl. 707/200

(57) ABSTRACT

Systems and methods are disclosed for receiving a request to perform a file management action, such as deleting a file, and determining a current status of a file which will be acted upon as a result of the file management action. If the status of the file indicates that the file is not available to be acted upon, the file management action is placed in a queue and the status of the file is monitored. When a change in the file status indicates that the file is available to be acted upon, the file management action is executed and the queue is updated.

### BACKGROUND

The present invention relates generally to an apparatus and method for managing files. In particular, the present invention relates to methods and systems that can defer renaming of a file that is unavailable and perform notification related with deferred renaming of a file.

The use of computers and other devices that can utilize digital files, such as, for example, digital audio or video players, has proliferated over time for both business and recreational applications. As digital devices have become more available to users, it has also become increasingly popular to share files, or otherwise make the digital files available for use by multiple users. In addition, widespread use of computerized devices has led to an increase in the number of files generated and shared amongst users.

An increase in a number of files being created and used also increases the number of files which must be managed. File management can include renaming files, moving files from one directory to another, cutting files or other action. During normal use, such as when a document file is opened for editing, or when an audio file is being played, the file is made unavailable to a file management action that would affect the name of the file, or the location of the file in the directory structure. Typically a file status mechanism is changed to reflect that the file is in use and so long as the file is in use, the user is prevented from renaming or relocating the file.

This limitation can be particularly frustrating for a user trying to organize or manage a large number of files. For example, utilities are currently available to sequentially number files according to some criteria, such as the date the file was last saved, or according to an alphabetical listing. Such utilities can be particularly useful in organizing a large number of files. If one or more of a group of files that a user wishes to organize is unavailable, sequential ordering for an entire set of files can be disrupted. In a similar way, if a small subset of files from a group of files that a user wishes to move is unavailable, the user will need to either wait until each file becomes available, or individually address each situation in which a file is unavailable, such as, for example, by contacting a user who has opened a file and ask them to close the file concerned.

Therefore, it would be advantageous to provide a method and apparatus that overcame the drawbacks of the prior art. In particular, it would be desirable to provide a method and apparatus that enables a user to implement renaming of a file regardless of whether the file is in use at a particular moment. In addition, it would be desirable to notify appropriate users that a file has been renamed.

### SUMMARY

Accordingly, the present invention includes systems and methods for facilitating file management which allow a request to perform a file management action on a file to be received and a current status of the file to be determined. If the current status of the file does not allow the file to be acted upon at a current time, the file management action can be queued until a changed status of the file allows the file to be acted upon. The current status can be monitored for the changed status and the file management action can be automatically performed on the file after the changed status is in effect.

A current status of a file can reflect, for example, the file being opened or that too many files are opened simultaneously, and a changed status can indicate the file being closed. A file management action can include, for example: renaming the file; moving the file to a different path in a directory structure; cutting the file to a clipboard; deleting the file or other action.

In another aspect, embodiments can include notifying a user who has recently accessed the file including details of the file management action performed. Embodiments can also include viewing a file and entering a file management action into the queue while the file is being viewed.

Still another aspect can include determining if the file has been modified since a command to delete the file has been entered into queue and notifying a user who made the modification of the pending command to delete the file, wherein the user who made the modification can be allowed to override the pending command to delete the file.

Other embodiments can include a system for implementing the steps for facilitating file management. The system can include a data storage medium storing electronic files and a computerized device for accessing the files stored on the data storage medium. Software can be operative with the computerized device and cause the computerized device to receive a request to perform a file management action on a file and determine a current status of the file. If the current status of the file does not allow the file to be acted upon at a current time, the file management action can be queued until a changed status of the file allows the file to be acted upon. The current status can be monitored for the changed status and the file management action can be automatically performed on the file after the changed status is in effect.

Embodiments can also include computer executable program code residing on a computer-readable medium or a data signal implementing the inventive concepts of the present invention. The program code can include instructions for causing a computer to implement various aspects of the invention as described throughout the specification and claims.

Various features and embodiments are further described in the following figures, description and claims.

### DESCRIPTION OF THE DRAWINGS

FIG. 1 illustrates a block diagram illustrating major components included in some exemplary embodiments of the invention.

FIG. 2 illustrates components of a system that can be utilized while implementing some exemplary embodiments of the present invention.

FIG. 3 illustrates a flow of exemplary steps that can be executed while implementing some embodiments of the present invention.

FIG. 4 illustrates a flow of exemplary steps from the perspective of a user that can be executed while implementing some embodiments of the present invention.

FIG. 5 illustrates an exemplary data structure that can be utilized in a database implementing some embodiments of the present invention.

FIG. 6 illustrates an exemplary graphical user interface that can be utilized in conjunction with some embodiments of the present invention.

### DETAILED DESCRIPTION

The present invention includes systems and methods for facilitating file management actions. In particular, systems and methods are disclosed for receiving a request to perform a file management action and determining a current status of a file which will be acted upon as a result of the file management action. If the status of the file indicates that the file is not available to be acted upon, the file management action is placed in a queue and the status of the file is monitored. When a change in the file status indicates that the file is available to be acted upon, the file management action is executed and the queue is updated.

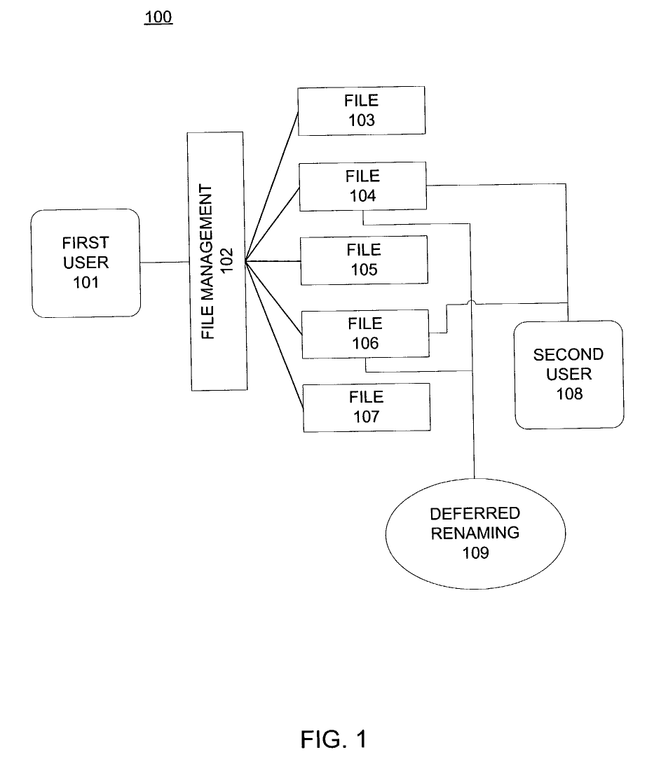

Referring now to FIG. 1, a block diagram illustrating some embodiments of the present invention is provided. A first user 101 can execute one or more file management actions 102 on a set of at least one file 103-107. The files 103-107 can also be utilized by a second user 108. Utilization of the files by a second user 108 can cause a change in file status. The file status can indicate whether the file 103-107 is available for file management actions. If the file is not available to be acted upon by a file management action 102, the file management action 102 can be placed in a deferred renaming queue 109.

Utilization of a file can include, for example: opening the file for editing or viewing; playing back an audio or video file; including the file in a file management command, such as: a file copy, file move, file delete, or other action acting on a file; or any other action which changes the status of a file from an available status to an unavailable status. For example, various operating systems and applications will utilize various mechanisms to indicate the status of a file, such as through a file status key or a file return code. A value can be placed in the file status key before execution of any request that will involve the file. The value placed in the status key can indicate the status of the request. If completion of the request is still pending, the file status key will indicate that the file is not available for a subsequent request. Typically, an exception or error message will be generated to indicate the unavailability of the file.

Some operating systems or applications may include steps that can be taken to address the condition encountered when trying to execute a request on a file that is already in use, or otherwise unavailable. For example, a message can be generated on a display that indicates that a command could not be completed because the file is in use by a particular program or user and that closing the program named may alleviate the problem.

Exemplary conditions that may prevent the completion of a file management action and result in the request being placed in a file management queue until the status of the file permits the request to be completed, can include: insufficient buffer space; attempt to write to a file opened for input; attempt to input from a file opened for output; disk space exhausted; attempt to open a file that is already open; too many files opened simultaneously; a device or resource necessary to complete the request is busy; a device or resource necessary to complete the request is unavailable; the file is locked; the file is already open; operating system shared file limit exceeded; or other condition which can prevent immediate completion of a file management action, such as renaming or moving a file.

Some implementations can include ascertaining an identity of a second user 108 accessing a file, wherein the access by the second user 108 prevents a file management action 102 from being completed and notifying the second user 108 that the request has been placed in a queue. The second user 108 can then be kept apprised of where the file can be found for subsequent access. Similar embodiments can ascertain a predetermined number of most recent file accesses and determine users that were involved with the most recent accesses. The users included in those determined as the most recent accessors can be notified of a renaming of a file name or change in the location of the file, or other file management action executed.

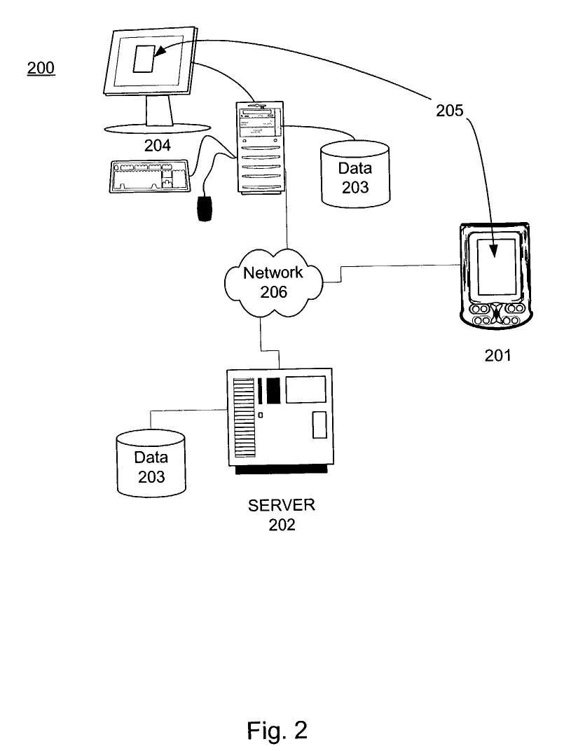

Referring now to FIG. 2, a network diagram illustrating some embodiments of the present invention is shown 200. A file management action system 100 can include a computerized file management action server 202 including data medium 203 accessible via a communications network 206, such as the Internet, a private network, a local area network (LAN) or direct link. A first user 101, second user 108 or other user can utilize a computerized device 204 to receive, input, transmit or view information processed in the file management action server 202. A protocol, such as the transmission control protocol Internet protocol (TCP/IP) can be utilized to provide consistency and reliability.

A computerized device 201 204 can be utilized to access the file management action server 202. The computerized device 201 204, such as a personal computer, terminal, workstation, wireless device or other network access device can include a processor, memory, user input device, such as a touch screen or keyboard and/or mouse, and a user output device, such as a display screen and/or printer. A computing device 201 204 can communicate with the file management action server 202 to access data and programs stored on the file management action server 202, or to run applications hosted on the file management action server 202. The computing device 201 204 may interact with the file management action server 202 as if the file management action server 202 were a single entity in the network 206. However, the file management action server 202 may include multiple processing and database sub-systems, such as cooperative or redundant processing and/or database servers that can be geographically dispersed throughout the network 206.

Some embodiments can include a single computing device 201 204 with a data medium 203 integrated into the computing device 201 204 or directly connected to the computing device 201 204. Files stored on the data medium 203 can be managed according to the inventive concepts of the present invention.

Typically a first user 101, second user 108 or other interested party, will perform queued file management actions 102 using deferred renaming software executed at a computing device 201 204. The deferred renaming software may include operating system software, application program software, a generic hypertext markup language (HTML) browser, or other software. In some cases, an executable program, such as a Java™ program, may be downloaded from a file management action server 202 to a computing device 201 204 and executed at the computing device 201 204. Other implementations can include proprietary software installed from a computer readable medium, such as a DVD or CD ROM. Embodiments of the invention may therefore be implemented in digital electronic circuitry, computer hardware, firmware, software, or in combinations of the above. As such, some apparatus of the invention may be implemented in a computer program product tangibly embodied in a machine-readable storage device for execution by a programmable processor; and method steps of the invention may be performed by a programmable processor executing a program of instructions to perform functions of the invention by operating on input data and generating output.

Software operative with the computing device 201 204 can be utilized to implement various steps in facilitating file management according to embodiments of the present invention. The software can cause an interface 205 on a display device associated with a relevant computing device 201 204.

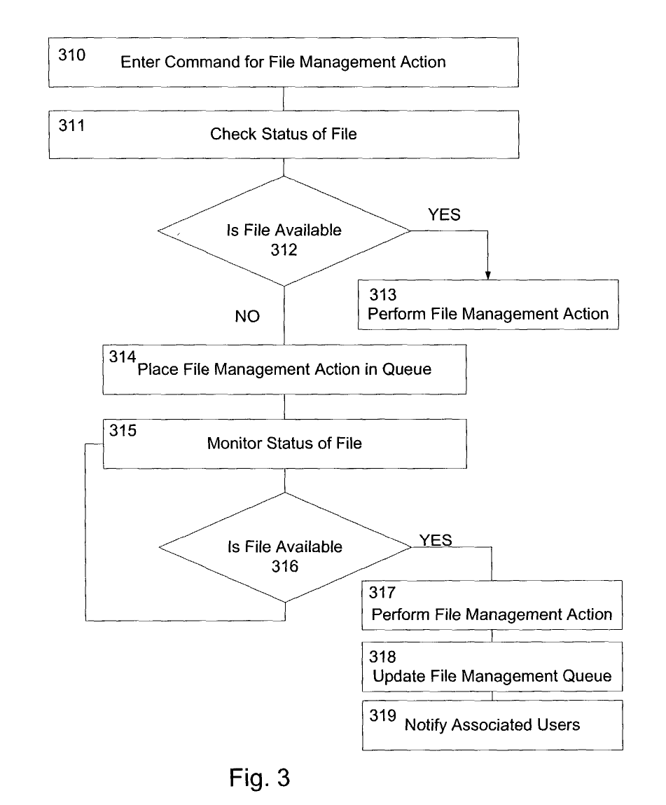

Referring now to FIG. 3, exemplary steps that can be implemented in some embodiments of the present invention are illustrated. A command to perform a file management action 102, such as a command to rename a file, can be entered 310 causing the status of a file to be checked 311. The status of the file can be utilized to determine if the file is available 312. If the file is available, the file management action 102 can be executed 313. If the file is not available, the file management action can be placed in a queue 314. With the file management action in queue, the status of the file can be monitored 315.

Monitoring the status of the file 315 can determine if the file becomes available 316. If the file becomes available, the file management action 102 placed in the queue can be executed 317 and the file management action queue can be updated.

Some embodiments can also include associated users being notified 319, such as a most recent second user 108 or a predetermined number of previous users to access the file, or any user that has accessed the file within a specified time period.

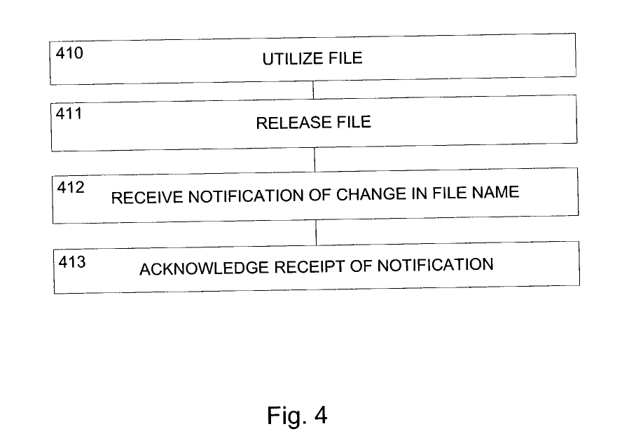

Referring now to FIG. 4, exemplary steps are illustrated which can be implemented from the perspective of a second user 108, or other party, implementing some embodiments of the present invention.

The second user 108 can access and utilize the file 410 and release the file 411 upon completion of the task engaged in by the second user 108. Subsequent to releasing the file 411, a queued file management action can be completed, such as renaming the file. The second user 108 can receive notification that a change in the name of the file and/or other file management action has been completed 412. Some embodiments can include the second user acknowledging receipt of notification that the file management action has been completed 413.

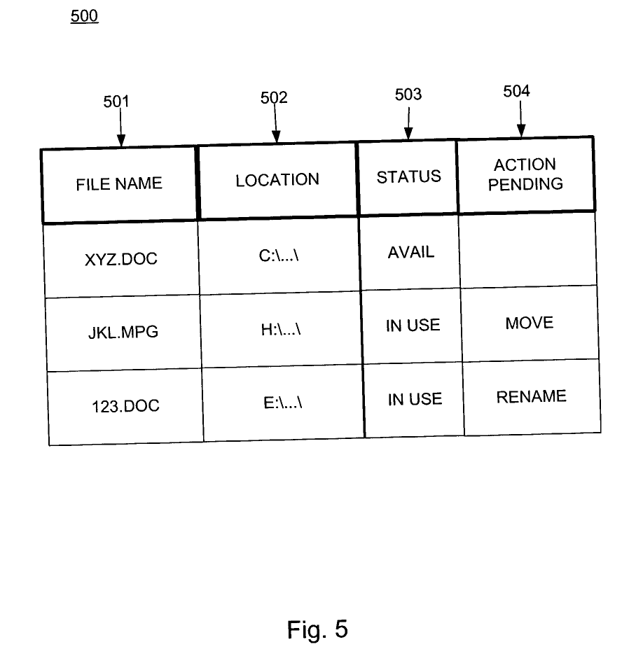

FIG. 5 illustrates an exemplary data structure that can be utilized in a database 203 implementing some embodiments of a deferred renaming. The exemplary database structure 500 can include: a field containing the name of a file involved 501, a field for the location of the file 502, such as a drive and directory path of the file; a status field containing data indicative of a current status of the file 503; and an action pending field 504 containing a description of an action to be taken on a file, such as renaming the file, when the file indicates that the file has become available; and any other data field that may be useful to implementing deferred renaming of the file.

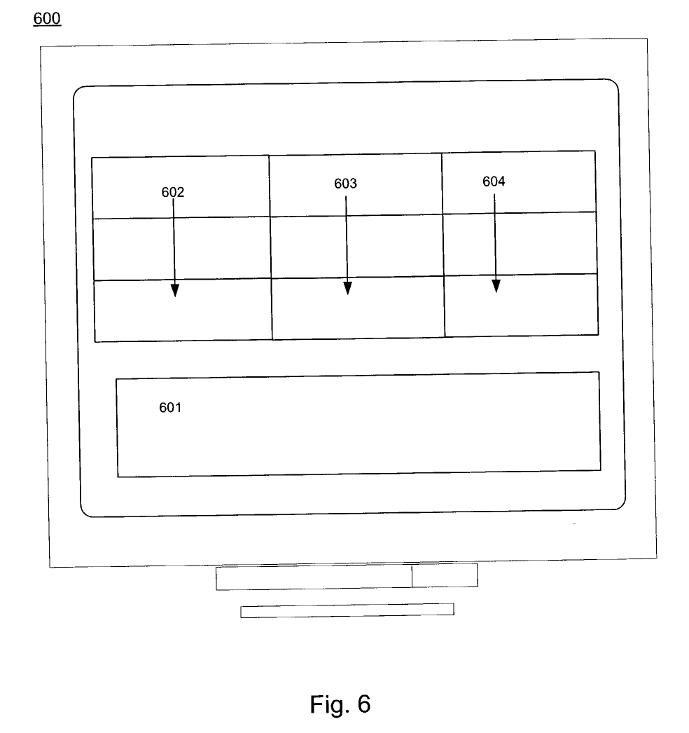

Referring now to FIG. 6, an exemplary GUI 600 for presenting various aspects of the present invention on a display, such as a display utilized in conjunction with a computerized device 201 204, is illustrated. The GUI 600 can include geographic areas of a user interface containing a status of a renaming request 601, file names 602, such as, for example, a current name of the file. Additional areas can include a user currently accessing the file 603, a modified name which results from renaming the file 604, or other functional area.

A number of embodiments of the present invention have been described. Nevertheless, it will be understood that various modifications may be made without departing from the spirit and scope of the invention. For example, some embodiments can include a first user viewing files and being enabled to enter a file management command into a queue while still viewing the file, such as a command to rename, delete, or cut a file. The command in queue can be subsequently completed after the user has completed viewing the file and causing the status of the file to change and make the file available to be acted upon. Accordingly, other embodiments are within the scope of the following claims.

What is claimed is:

1. A method for facilitating file management, the method comprising:
receiving a request to perform a file management action on a file;
determining a current status of the file;
if the current status of the file does not allow the file to be acted upon at a current time, enabling the file management action to be queued until a changed status of the file allows the file to be acted upon;
monitoring the current status for the changed status; and
automatically performing the file management action on the file after the changed status is in effect.

2. The method of claim 1 wherein the current status reflects the file being opened.

3. The method of claim 1 wherein the changed status indicates the file being closed.

4. The method of claim 1 wherein the file management action comprises renaming the file.

5. The method of claim 1 wherein the file management action comprises moving the file to a different path in a directory structure.

6. The method of claim 1 wherein the file management action comprises cutting the file to a clipboard.

7. The method of claim 1 wherein the file management action comprises deleting the file.

8. The method of claim 1 additionally comprising the step of notifying a user who has recently accessed the file with information descriptive of the file management action performed.

9. The method of claim 1 additionally comprising the step of viewing the file and entering the file management action into the queue while the file is being viewed.

10. The method of claim 1 wherein the current status reflects too many files being opened simultaneously.

11. The method of claim 7 additionally comprising the steps of:
determining if the file has been modified since the command to delete the file has been entered into queue;
notifying the user who made the modification of the pending command to delete the file; and
allowing the user who made the modification to override the pending command to delete the file.

12. A system for facilitating file management, the system comprising:
a data storage medium storing electronic files;
a computerized device for accessing the files stored on the data storage medium;
software operative with the computerized device for causing the computerized device to:
receive a request to perform a file management action on a file;
determine a current status of the file and if the current status of the file does not allow the file to be acted upon at a current time, enable the file management action to be queued until a changed status of the file allows the file to be acted upon;
monitor the current status for the changed status; and
automatically perform the file management action on the file after the changed status is in effect.

13. The system of claim 12 additionally comprising a means for notifying a recent user accessing the file of the file management action completed.

14. The system of claim 12 wherein the data storage medium is accessed by the computerized device via a communications network.

15. The system of claim 11 wherein the network access device comprises a wireless communications device.

16. The system of claim 11 wherein the software comprises an operating system.

17. Computer executable program code residing on a computer-readable medium, the program code comprising instructions for causing a computer to:
receive a request to perform a file management action on a file;
determine a current status of the file and if the current status of the file does not allow the file to be acted upon at a current time, enable the file management action to be queued until a changed status of the file allows the file to be acted upon;
monitor the current status for the changed status; and
automatically perform the file management action on the file after the changed status is in effect.

18. The computer executable code of claim 17 wherein the computer executable code additionally comprises instructions for causing the computer to:
transmit a notice of a file management action to a user most recently accessing the deleted file.

19. The computer executable code of claim 17 wherein the computer executable code additionally comprises instructions for causing the computerized device to:
allow a user most recently accessing the file to override the file management action placed in queue.

20. The computer executable code of claim 17 wherein the computer executable code additionally comprises instructions for causing the computer to:
receive authorization from the user most recently accessing the file to proceed with the file management action.
